(19) United States
(12) Patent Application Publication
(10) Pub. No.: US 2015/0276169 A1
(43) Pub. Date: Oct. 1, 2015

(54) MULTI-MODE LUMINAIRE AND MULTI-DISTRIBUTION LENS

(71) Applicant: SYLVAN R. SHEMITZ DESIGNS INCORPORATED, West Haven, CT (US)

(72) Inventors: Matthew R. BULLARD, Milford, CT (US); Paul FORD, Orange, CT (US); David R. PFUND, Woodbridge, CT (US)

(21) Appl. No.: 14/586,924

(22) Filed: Dec. 30, 2014

Related U.S. Application Data
(60) Provisional application No. 61/921,792, filed on Dec. 30, 2013.
(60) Provisional application No. 61/953,012, filed on Mar. 14, 2014.

(51) Int. Cl. F21V 5/04; F21V 23/04; F21V 29/70; F21V 23/00

(52) U.S. Cl. CPC F21V 5/04; F21V 23/003; F21V 23/0435; F21V 29/70; F21Y 2101/02

(57) ABSTRACT

A multi-mode luminaire includes at least two opposed apertures for distributing light from two light members in an upwardly and downwardly direction. A heat transfer member disposed within the luminaire and between the light members functions as a mounting surface and heat sink for one of the light members and as an optical surface for redirecting light from the second light member. The opticalsurface allows the second light member to face internally and substantially away froman aperture viewed by a user, while light from the second light member is directed through the aperture and toward the user, below a cut-off angle. A switch disposed on the luminaire housing is configured for modulating a plurality of settings for the light members wherein the control circuit is configured to control the light output as a function of the switch and an operative source disposed in communication with the control unit. A further luminaire includes a single homogenous component lens wherein first and second halves of the lens are selected for manipulating the light distribution of the luminaire. The various configurations of the lens profile, achieve a particular light distribution, dependent on the lens material.

### TECHNICAL FIELD

The disclosure relates to a multi-mode luminaire having at least two opposed apertures for distributing light. More particularly, the disclosure relates to a luminaire having an uplight and downlight aperture and at least two light members separated by a heat transfer member wherein the heat transfer member provides for the support of a first light member of the luminaire and provides for the redirection of light emitted by a second light member of the luminaire.

This disclosure also relates to lenses used for manipulating the light distribution of a luminaire. More particularly, the disclosure relates to a co-extruded polymeric refractive lens profile wherein the lighting performance of the lens is varied depending on the combination of lens material used.

### BRIEF SUMMARY

The drawbacks and deficiencies of conventional luminaires are overcome or alleviated by providing a luminaire having a first aperture emitting light from a first light member and a second aperture emitting light from a second light member. The luminaire further includes a switch having a first position and a second position configured to modulate a plurality of settings for the first and second light members. A control unit is configured to control the light output from the first and second light members as a function of the switch. An operative source disposed in communication with the control unit is configured to instruct the control unit to operate the luminaire through a plurality of modes.

A further luminaire lens is provided for use in conjunction with a luminaire, the lens having one homogenous component configured to emit a multi-distribution intensity profile. A first half of the lens includes a first input port and a second half of the lens includes a second input port. The first half is made of a first material and a second half is made of a second material such that the same or different materials could be used in the lens.

The above discussed and other features and advantages of the present disclosure will be appreciated and understood by those skilled in the art from the following description and drawings.

### BRIEF DESCRIPTION OF THE DRAWINGS

Referring to the exemplary drawings wherein like elements are numbered alike in the several FIGS.:

FIG. 1 is a sectional view of an exemplary embodiment of a dual-aperture luminaire;

FIG. 1A is another sectional view of the luminaire of FIG. 1;

FIG. 2 is a partial rear elevation view thereof;

FIGS. 3 and 4 are top perspective views thereof;

FIGS. 5 and 6 are bottom perspective views thereof;

FIG. 7 is a flowchart showing a control system thereof;

FIG. 8 is a flowchart showing a calibration subroutine of the luminaire control system shown in FIG. 7;

FIGS. 9 and 10 are schematics showing the LED board of the uplight and downlight thereof;

FIG. 11 is a candlepower distribution plot of the uplight and downlight thereof;

FIG. 12 is a sectional view of an exemplary embodiment of a co-extruded multi-distribution lens;

FIGS. 13 and 14 are ray trace and candlepower distribution plots of the clear material lens used in the exemplary embodiment thereof;

FIGS. 15 and 16 are ray trace and candlepower distribution plots of an opaque and clear material lens used in the exemplary embodiment thereof;

FIG. 17 is a top perspective view of an exemplary embodiment of a multi-distribution luminaire;

FIG. 18 is a bottom perspective view thereof;

FIG. 19 is a sectional view thereof;

FIG. 20 is a candlepower distribution plot of the lens used in the exemplary embodiment thereof;

FIG. 21 is a top perspective view of another exemplary embodiment of a multi-distribution luminaire;

FIG. 22 is a bottom perspective view thereof;

FIG. 23 is a rear perspective view thereof; and

FIG. 24 is a sectional view thereof.

### DETAILED DESCRIPTION OF THE PREFERRED EMBODIMENTS

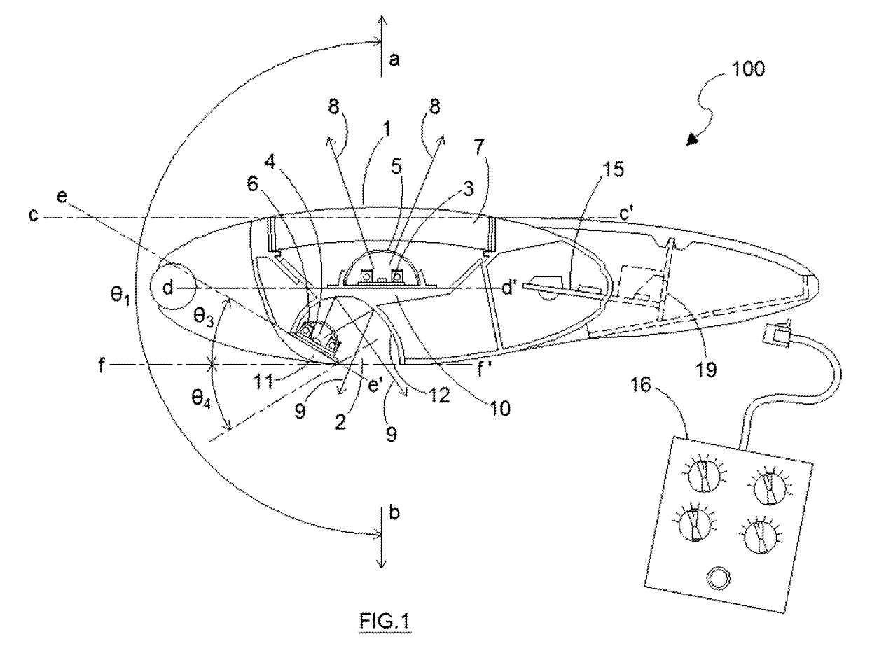

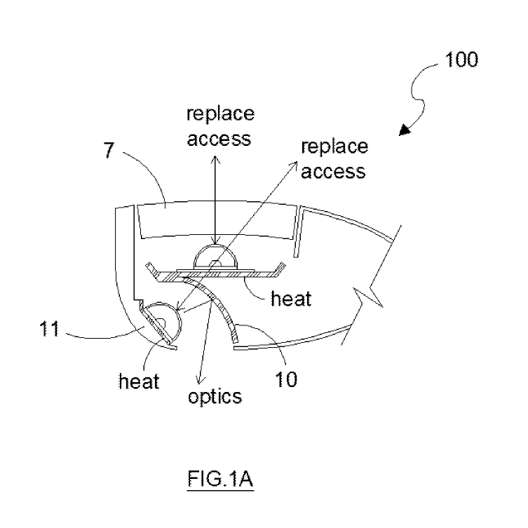

FIG. 1 is a sectional view of a luminaire 100 having at least first and second opposed apertures. In this embodiment, first aperture is an uplight aperture 1, and second aperture is a downlight aperture 2 wherein uplight aperture 1 and downlight aperture 2 face substantially opposite directions and are located, respectively, in planes c-c′ and f-f′. Preferably, uplight aperture 1 faces upwardly towards direction a, and downlight aperture 2 faces downwardly towards direction b wherein both directions a and b are perpendicular to (i.e., normal to) planes c-c′ and f-f′ and angle θ1 is approximately 180°. As seen in FIG. 1, a first light member 3 is a plurality of light emitting diodes (LEDs) is disposed below uplight aperture 1 and is associated with heat transfer member 10 along mounting plane d-d′. Specifically, light member 3 emits light in one hemisphere and substantially away from mounting plane d-d′. Collectively, mounting plane d-d′ and light member 3 are disposed to direct light through refractor 5 and substantially in the direction of and through uplight aperture 1, the refractor 5 being disposed substantially beneath uplight aperture 1 and above light member 3. Refractor 5 is preferably a hemi-shaped tube for distributing light from light member 3 through uplight aperture 1. Luminaire 100 further includes a glare control louver 7 disposed between the refractor 5 and uplight aperture 1. Specifically, light is emanated 8 from refractor 5 and reflected through glare control louver 7 to emanate 8 above the luminaire 100. Glare control louver 7 is substantially wider than refractor 5 and preferably extends along the area of uplight aperture 1 to control the emanation 8 of light from light member 3 through uplight aperture 1. In this embodiment, optical surface 12 is also a surface of heat transfer member 10 and receives and reflects light emanations 9 from a second light member 4 as a plurality of LEDs of the luminaire 100. Alternatively, optical surface 12 is applied to, or attached to, heat transfer member 10. Specifically, light member 4 is disposed above downlight aperture 2 and associated with heat transfer member 11 along mounting plane e-e′. Light member 4 emits light in one hemisphere and substantially away from mounting plane e-e′. Collectively, mounting plane e-e′ and light member 4 are disposed to direct light emanations 9 away from downlight aperture 2, through refractor 6, and toward optical surface 12 whereby they are reflected to pass through downlight aperture 2 and emanate below the luminaire 100.

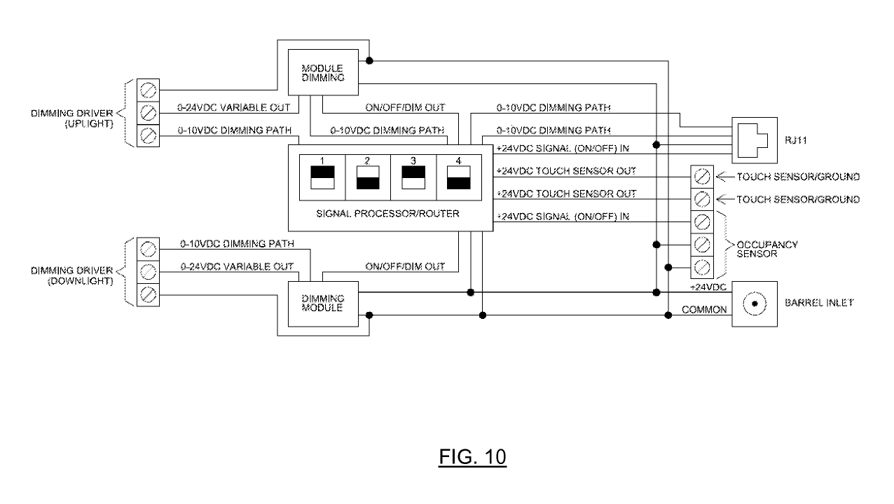

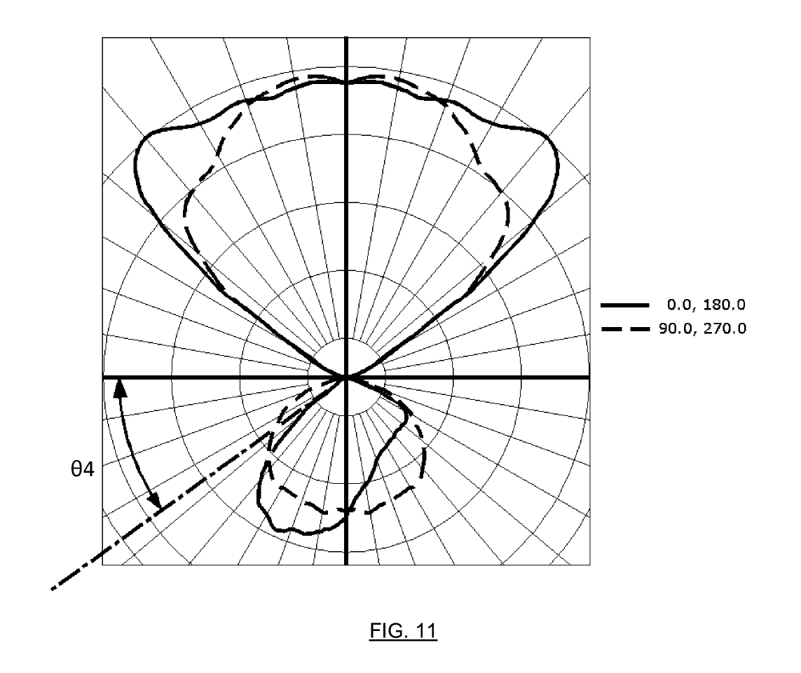

Referring again to FIG. 1, in a preferred embodiment, mounting plane d-d′ is generally parallel with lighting aperture planes c-c′ and f-f′ and angle θ2 between mounting plane e-e′ and mounting plane d-d′ is less than 90 degrees; and angle θ3 between mounting plane e-e′ and aperture plane f-f′ is less than 90 degrees. This preferred arrangement of light member 4, optical surface 12, and down light aperture 2 provides for an asymmetric, forward-throw distribution of light emanations from downlight aperture 2 toward a viewer of the luminaire, as exemplified by FIG. 11, while advantageously shielding the viewer from glare when the viewer is positioned to observe the aperture along sightlines that occur within the cut-off angle θ4. It is further advantageous that optical surface 12 is a surface of heat transfer member 10 or is applied to, or attached to, heat transfer member 10 as these embodiments reduce the complexity of the luminaire manufacturing and assembly process and facilitate post-production and in-situ access to light member 4 via uplight aperture 1 for service and replacement, said access via uplight aperture 1 further allowing downlight aperture 2 to be minimized and not sized for the installation and servicing of light member 4.

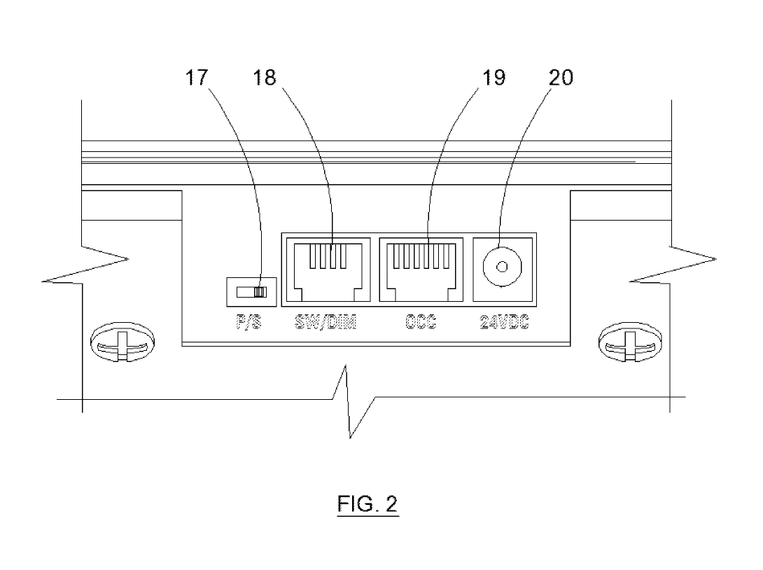

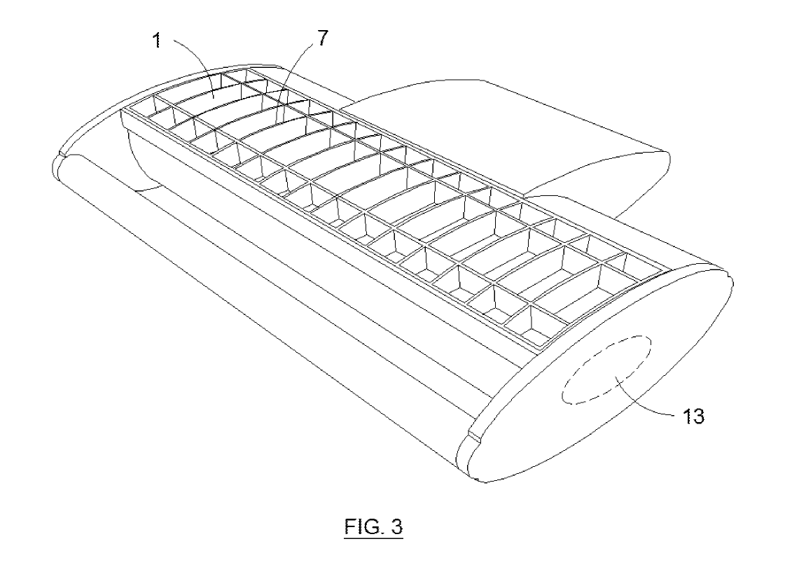

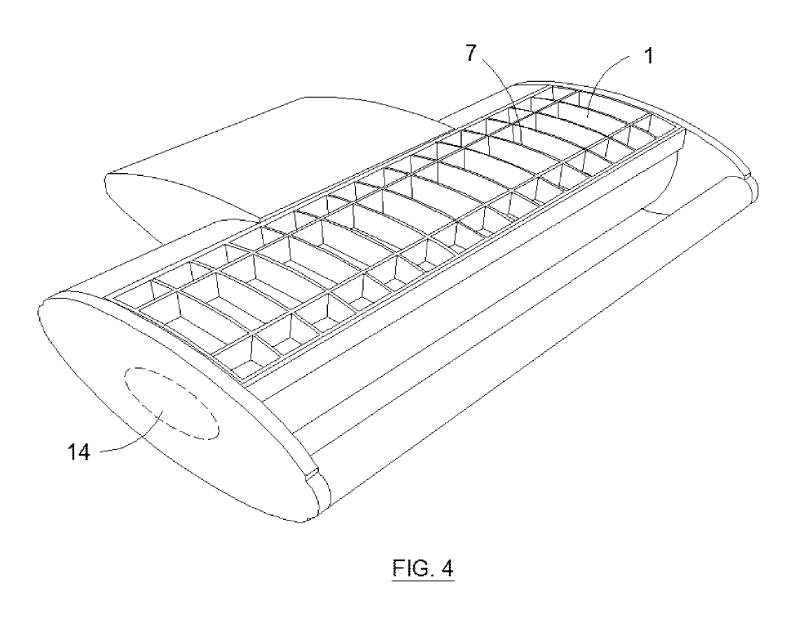

As seen in FIGS. 1 and 2, the luminaire 100 is equipped with an internal control circuit 15 or control unit with standby timer for activating the light members 3, 4 and to control the light output there from as a function of a mode switch 17. The internal control circuit 15 may also include a cumulative-hour counter (e.g., lifetime timer) for each of the light members 3, 4, an auto-off timer for use in conjunction with a motion sensor, and an auto-calibration routine for setting the touch sensitivity of control input touch surfaces 13, 14, seen in FIGS. 3 and 4. The internal control circuit 15 determines the maximum output of light member 3 and light member 4 and thus, determines the maximum operating/input wattage of the luminaire 100. The mode switch 17 includes a first position and a second position configured to modulate a plurality of settings for the light members 3, 4. An operative source is disposed in communication with the internal control circuit 15 and configured to instruct the internal control circuit 15 to operate the luminaire 100 through a plurality of modes. For example, the operative source could include control inputs 13, 14 of the luminaire 100, standby timer, motion sensor, auto-off timer, lifetime timer, remote control port, or remote programming device.

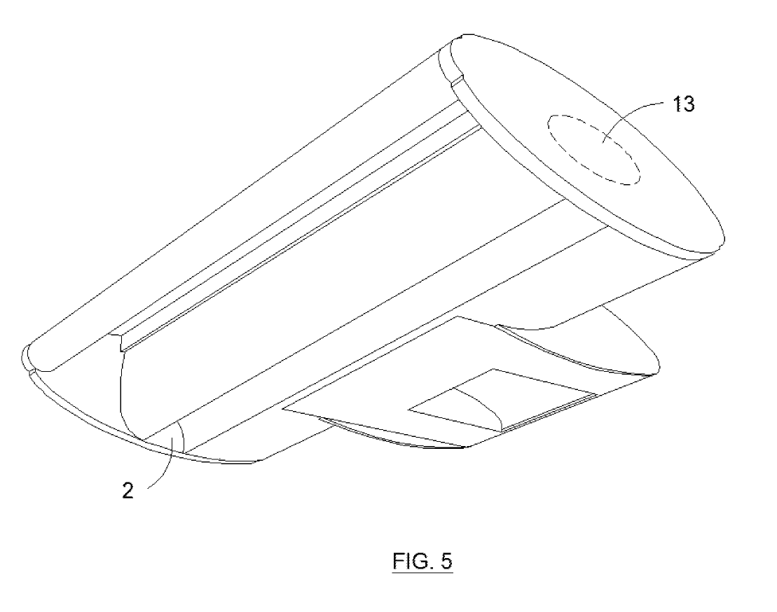

Turning to FIGS. 3-6, the luminaire 100 includes capacitive touch surfaces for modulating the output of light member 3, or light member 4, or both light members 3, 4 via the internal control circuit 15, and for activating at least one configuration mode of the internal control circuit 15. Control input 13 is a capacitive touch surface located on one of the left and right sides of the luminaire. Control input 14 is a capacitive touch surface located on the other of the left and right sides of the luminaire, opposite that of control input 13. In the illustrated embodiment, control inputs 13, 14 are located towards the center of the side surfaces of the luminaire 100, allowing for ease and accessibility by a user. In another embodiment, control input 13 and control input 14 are momentary contact devices. Furthermore, in a preferred embodiment, control circuit 15 is configured to communicate with capacitive touch surfaces and with momentary contact devices allowing either type of control input or a combination of control input types to be used with control circuit 15.

When the mode switch 17 is in a first position (i.e., private mode, ‘P’ hereinafter, or shared mode, ‘S’ hereinafter), (1) control input 13 switches and/or modulates light member 3 output within a first prescribed output range via the internal control circuit 15 and (2) control input 14 switches and/or modulates light member 4 output within a second prescribed output range via the internal control circuit 15, so long as power is supplied to the luminaire 100 via the power input port 20. Power input port 20 could be a receptacle for a 2.1 mm barrel connector. Furthermore, when power is supplied to the luminaire 100 and the mode switch is in the first position (i.e., P or S), signals received via control port 18 are configured to control light member 3 in combination with control input 13. When power is supplied to the luminaire 100 via the power input port 20 and the mode switch 17 is in a second position (i.e., P or S), both control input 13 and control input 14 modulate light member 4 within a third prescribed output range via the internal control circuit 15 and signals received via remote control port 18 control light member 3 output within a fourth prescribed output range via the internal control circuit 15. In all cases (i.e., mode switch 17 being in first and second positions), signals received via remote control port 18 may redefine the output range prescribed for light member 3, light member 4, or both. Furthermore, when power is supplied to the luminaire 100 via the power input port 20 and mode switch 17 is in the second position, some signals received via remote control port 18 could control light member 4 in combination with control input 13 and control input 14 and within the third prescribed output range, or within a predefined output range according to the signals received via control port 18. Signals received via remote control port 18 could be a dimming voltage or a switching voltage, or both. When mode switch 17 is in the second position and there is no remote control connection at control port 18, then the light member 3 will remain at the maximum output defined by the fourth output range so long as power is supplied to the luminaire 100 via the power input port 20.

To achieve optimal thermal operation of light member 3 and light member 4 and/or to limit the power input at power input port 20, the first, second, third, and fourth prescribed output ranges may each be limited by control circuit 15 according to respective prescribed maximum output limits.

Luminaire 100 may include a light sensor that modulates the output of light member 3 via the internal control circuit 15 in combination with or exclusive of dimming signals received via remote control port 18.

Referring to FIGS. 1 and 2, when power is supplied to the luminaire 100 via the power input port 20 and the mode switch 17 is in a first position (i.e., P or S) and a remote motion sensor is connected via the remote power and signal port 19, the internal control circuit 15 will turn off light member 4 and initiate a standby timer if signals from the motion sensor cease. When power is supplied to the luminaire 100 via the power input port 20 and the mode switch 17 is in a second position (i.e., P or S) and a remote motion sensor is connected via the remote power and signal port 19, the internal control circuit 15 will turn off both light member 3 and light member 4 and initiate a standby timer if signals from the motion sensor cease. Preferably, the remote motion sensor may be an integral motion sensor.

Regarding the standby timer, when the standby timer is running and motion is detected by the motion sensor, the internal control circuit 15 will re-energize whichever light members 3, 4 were turned off when signals from the motion sensor ceased, and the internal control circuit 15 will turn off and reset the standby timer. If the standby timer expires, the internal control circuit 15 will wait for a signal from control input 13 or control input 14 or alternatively, from the remote control port 18 to turn on one or both of the light members 3, 4, depending on the selected first or second position of the mode switch 17. The remote control port 18 could be an RJ11 jack, for example.

The luminaire 100 includes a feature for indicating to a user that the rated useful life of one of the light members 3, 4 has been exhausted and should be replaced. After either of light members 3, 4 has operated for a predetermined number of cumulative hours (e.g., the rated useful life of the light member), the internal control circuit 15 will cause the particular light member to flash each time that specific light member is energized (from the ‘off’ position) until that light member is replaced with a new light member. For example, when light member 3 has operated for a predetermined number of cumulative hours (e.g., the rated useful life of the light member 3), the internal control circuit 15 will cause the light member 3 to flash each time the light member 3 is energized (from the ‘off’ position) until a user replaces light member 3 with a new light member 3, which presumably includes a full rated useful life, and resets the cumulative-hour counter of the control circuit 15 for light member 3.

Referring back to FIG. 1, the remote programming device 16 connects to remote power and signal port 19 located towards the back of the lighting fixture 100. The remote programming device 16 is used to adjust, via the remote power and signal port 19, the internal control circuit 15 settings for maximum output of light member 3 and maximum output of light member 4 for mode switch position P, the internal control circuit 15 settings for maximum output of light member 3 and maximum output of light member 4 for mode switch position S, the internal control circuit prescribed output ranges, the standby timer period, an auto-off timer period for use with a motion sensor and the operating hours at which the maintenance minder ‘flash’ commences for light members 3, 4. Preferably, the remote power and signal port 19 is an RJ12 jack for connecting the remote motion sensor and/or control circuit programming device.

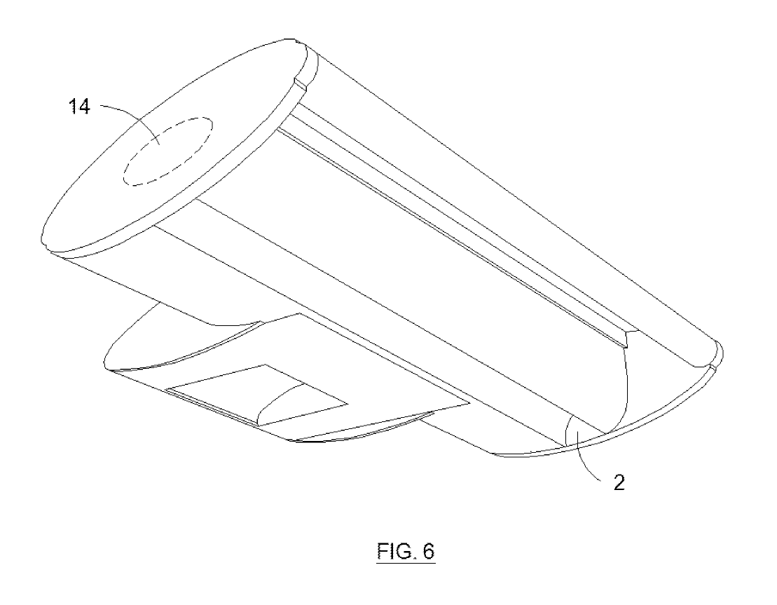

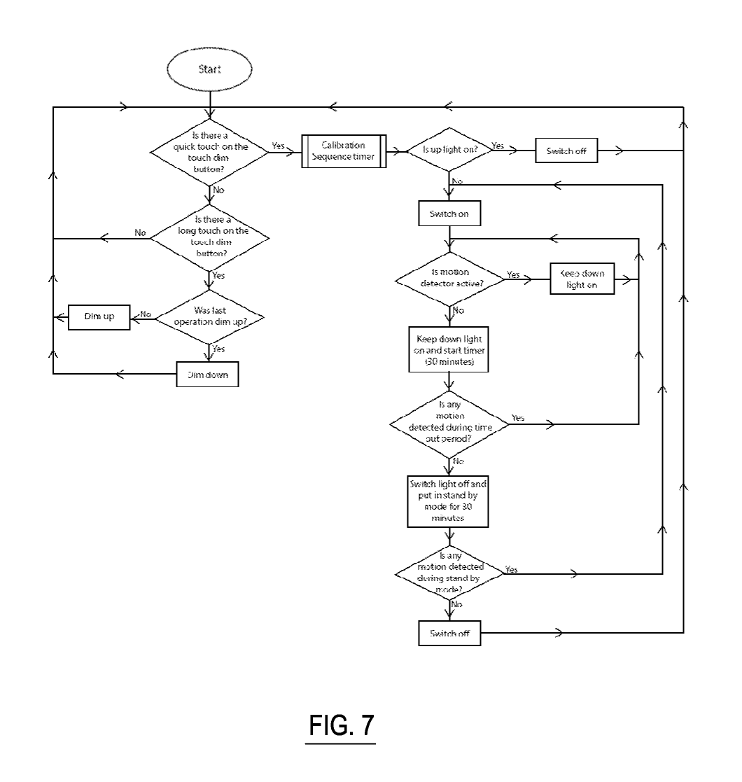

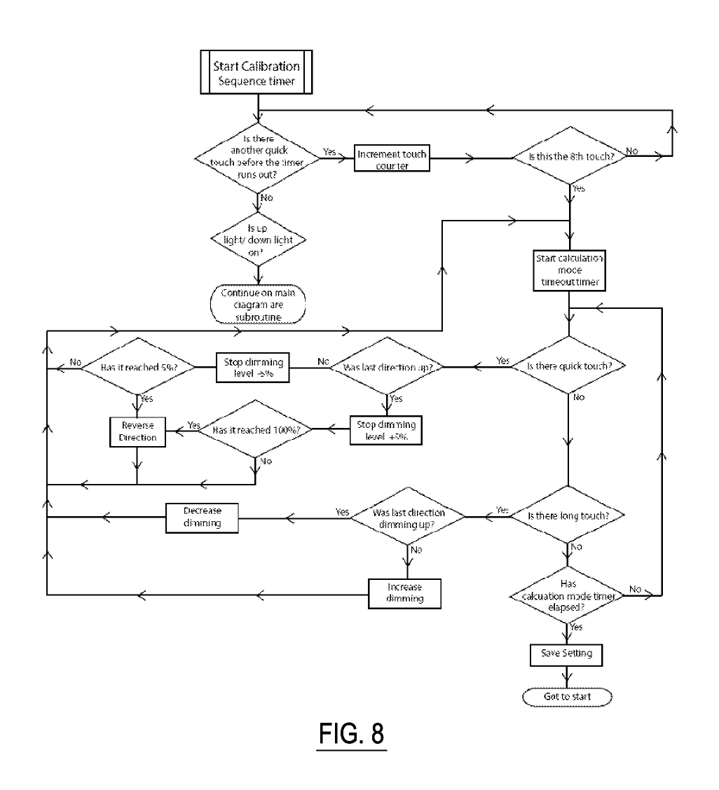

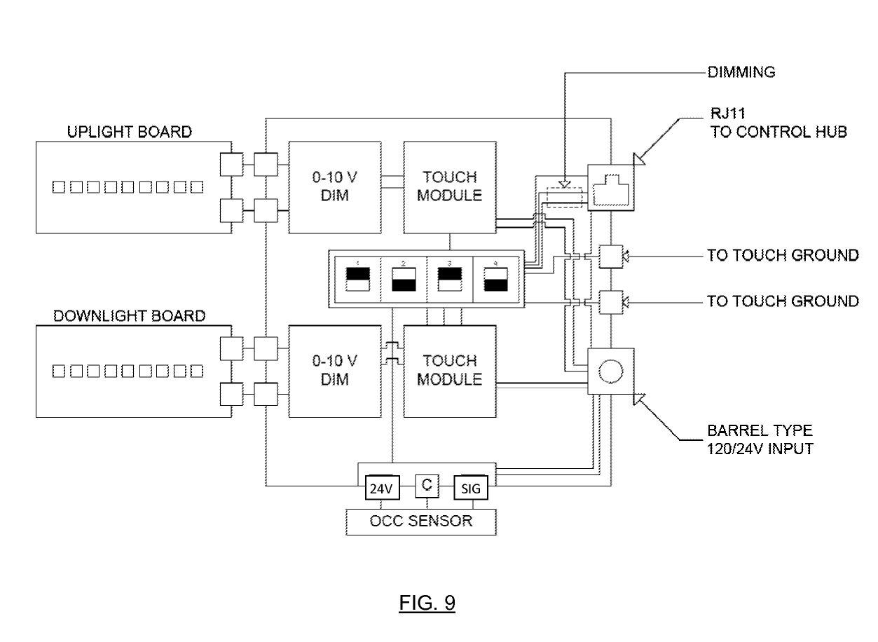

Referring to FIGS. 1, 2, and 7-10, in an alternative embodiment, at least one of control input 13 and control input 14 may be used to manually activate a configuration mode of the internal control circuit 15 to reset the lifetime timers for light member 3 and light member 4 and to adjust settings for maximum output of light member 3 and light member 4, the prescribed output ranges for light member 3, the prescribed output ranges for light member 4, the standby timer period, and the auto-off timer period. A user applying a series of sequential taps or presses (e.g., a plurality of rapid taps or rapid presses depending on the control input type, capacitive touch, or momentary contact) manually activates the configuration mode. For example, the series of taps/presses may be six rapid taps or rapid presses. Upon manual activation, the control circuit 15 provides a visual confirmation (e.g., flashing one or both light members 3, 4) and may commence a configuration mode timer. It is possible to apply subsequent taps (or presses) to at least one of control input 13 and control input 14 to select settings and change the setting values. The internal control circuit 15 provides visual confirmation of selected settings and values, again, by flashing one or both light members 3, 4. Again, a user applying a series of sequential taps or presses (e.g., six rapid taps or rapid presses) could deactivate the configuration mode. When the configuration mode timer (if any) is running, then a tap (or a press) on at least one of control input 13 and control input 14 resets the configuration mode timer. If a user does not apply any taps (or presses) within a predetermined time period (e.g., 20 seconds), then the configuration mode timer (if any) expires, causing the configuration mode to deactivate and the control circuit 15 to return to ‘normal’ operation and provide a visual confirmation of the same (e.g., flashing one or both light members 3, 4).

Furthermore, when a configuration mode of the internal control circuit is activated via control input 13 or via control input 14 and the mode switch 17 is in the first position, then the user may be able to adjust settings for the first prescribed output range and for the second prescribed output range only. Likewise, when a configuration mode of the internal control circuit is activated via control input 13 or via control input 14 and the mode switch 17 is in the second position, then the user may be able to adjust settings for the third prescribed output range and for the fourth prescribed output range only.

In another preferred embodiment, adjustment of some settings are not available in a first configuration mode of the internal control circuit 15 and are available in a second configuration mode of the internal control circuit 15, the second configuration mode being activated by applying a different series of sequential taps or presses than used to activate the first configuration mode (e.g., nine rapid taps or rapid presses). These may include settings for the maximum output limits for light member 3 and light member 4 in each of the two control modes associated with the positions of mode switch 17, the standby timer period, and the auto-off timer period. Settings for the standby timer period may include one that prevents the timer from expiring (e.g., auto-on is always enabled) and one that prevents the standby timer from operating (e.g., auto-on is disabled). Likewise, settings for the auto-off timer may include one which disables the auto-off timer (e.g., setting the auto-off timer period to zero) as this may be desirable when the control circuit is used in conjunction with a motion sensor that has an integral auto-off timer.

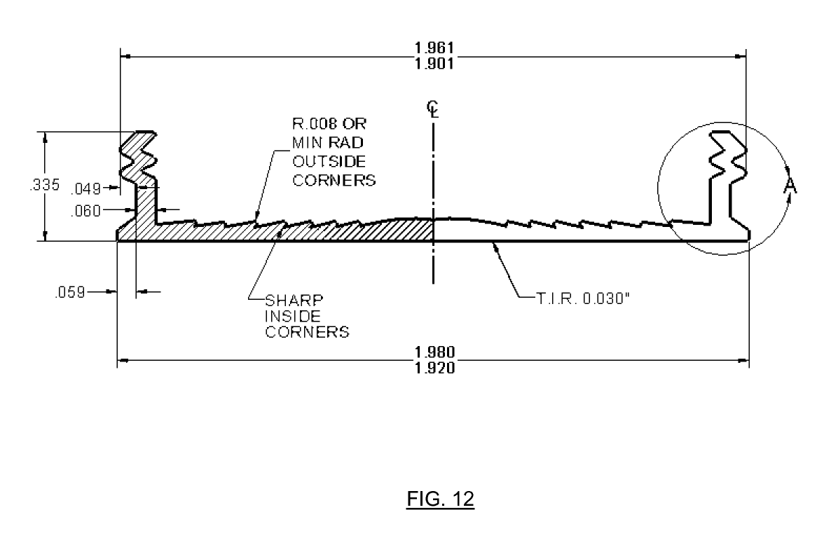

FIGS. 12-16 are directed to another embodiment generally related to lenses used for controlling or manipulating the light distribution of a luminaire. More specifically, FIGS. 13-16 illustrate ray trace and candlepower distribution plots for a luminaire having a multi-distribution lens with a single homogenous component. For example, the luminaire could include a co-extruded polymeric (acrylic) refractive lens profile. The same extrusion can be made into a variety of configurations by changing the material used and thus altering the light distribution of the luminaire. FIG. 12 illustrates an exemplary embodiment wherein the left and right halves of the profile are mirror images of each other. The extrusion tool includes first and second input ports such that different materials could be used in each of the first and second halves.

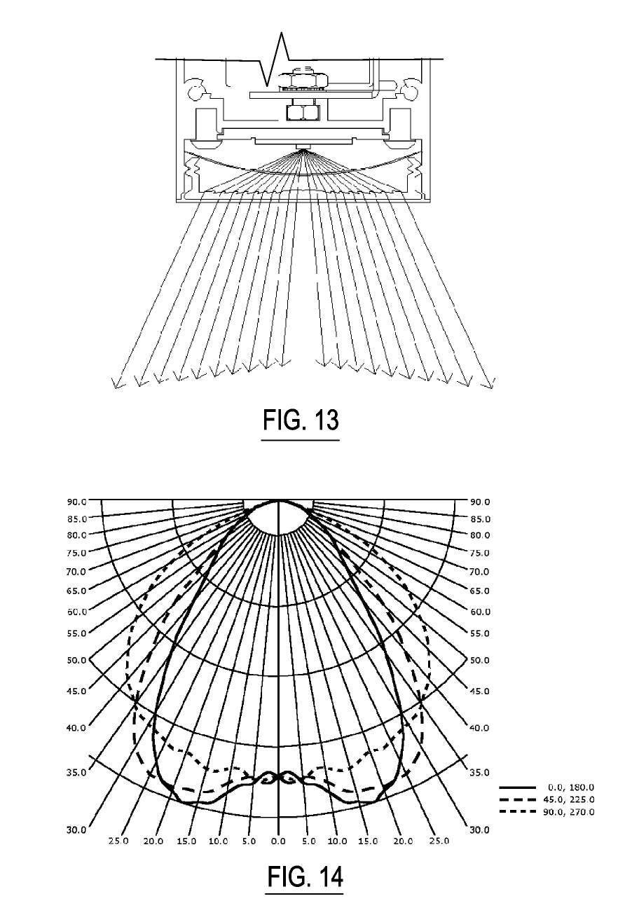

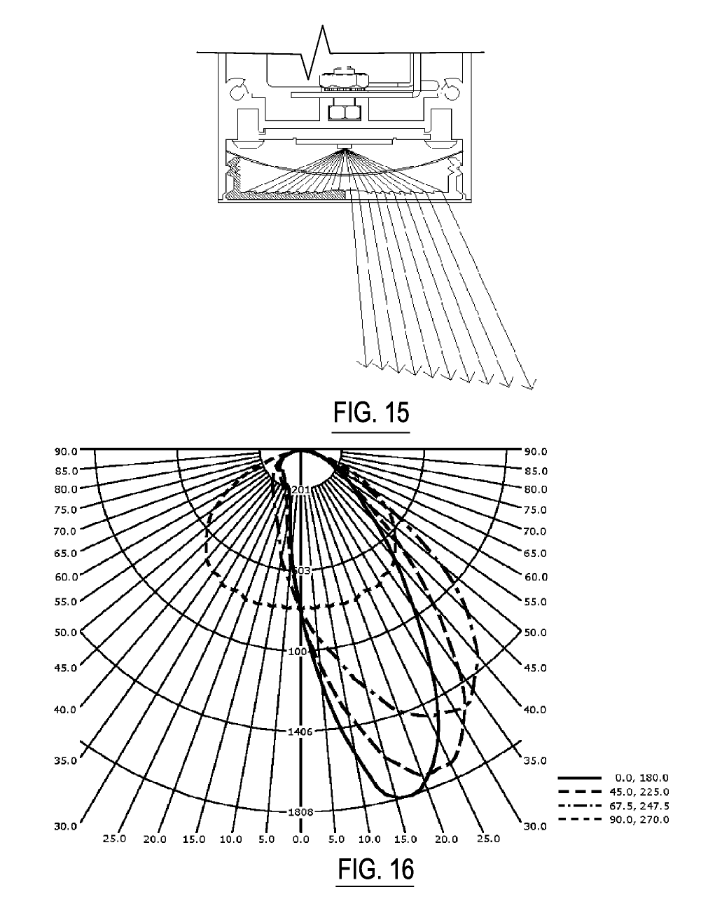

FIGS. 13-14 illustrate the distribution achieved when a clear material (i.e., clear acrylic) is used in both the first and second halves. The result is a bi-asymmetric distribution, ideal for lighting first and second opposing vertical surfaces. FIGS. 15 and 16 illustrate the distribution achieved when an opaque material is used in the first half and a clear material is used in the second half. The result is an asymmetric distribution, and could be used for lighting one vertical surface. Although not illustrated, when a translucent material is used in the first half and a clear material is used in the second half, the result is an asymmetric distribution in a first direction and a diffuse distribution in a second direction. In another configuration, if a translucent material is used in both the first half and the second half, the result is a diffuse symmetric distribution.

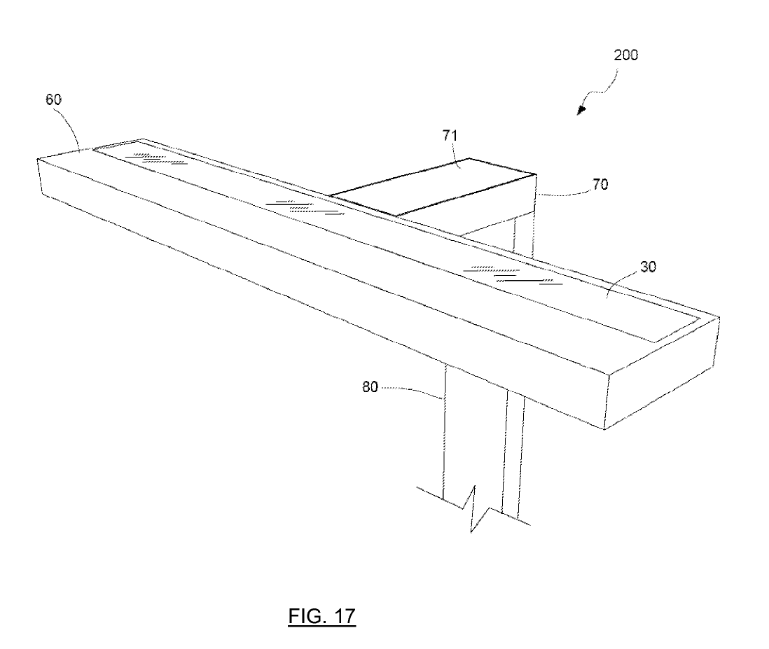

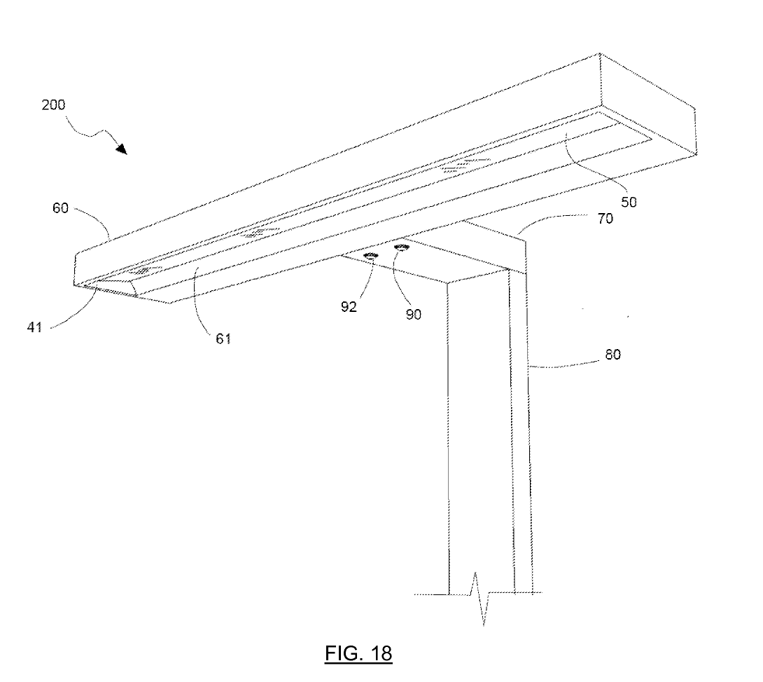

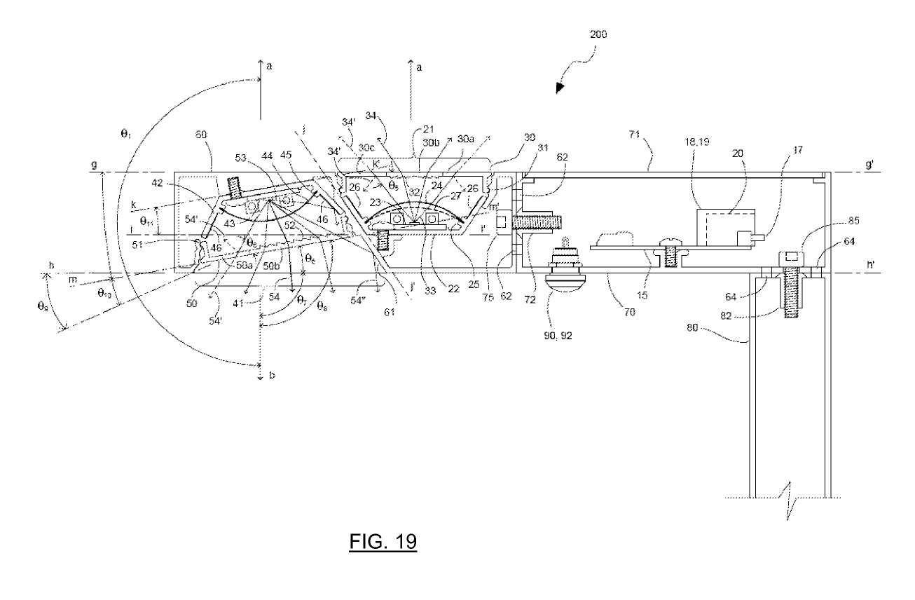

FIGS. 17-20 illustrate another preferred embodiment of the disclosure. Luminaire assembly 200 consists of a luminaire housing 60, an extension enclosure 70 with removable access cover 71, and mounting stanchion 80. Mounting stanchion 80 includes threaded feature 82 or screwport that accepts threaded fastener 85 and extension enclosure 70 includes threaded feature 72 that accepts threaded fastener 75. Threaded feature 82 may be two threaded features. Likewise, threaded feature 72 may be two threaded features, and threaded fasteners 75 and 85 may each be two threaded fasteners to provide for rigid connections and to assure alignments. Openings 62 and 64 provide for wiring between luminaire housing 60 and the extension enclosure 70 and between extension enclosure 70 and mounting stanchion 80, respectively. Removable cover 71 provides for access to connections (for assembly), wiring, internal control circuit 15, mode switch 17, remote control port 18, remote power and signal port 19, and power input port 20. Removable cover 71 may include snap fit features. Luminaire housing 60 includes a first uplight aperture 21 and a second opposed downlight aperture 41. Light member 22 and lens 30 are disposed in uplight aperture 21, and light member 42 and lens 50 are disposed in downlight aperture 41, respectively.

Light member 22 includes a flexible refractive overlay 24 and plurality of LEDs 23 and is associated with housing 60 along mounting planes i-i′ and j-j′ such that housing 60 also serves as a heat transfer member for light member 22. Light member 22 directs light through refractive overlay 24 in the direction of lens 30. Light member 22 includes opposing features 25 that capture opposing edges of flexible refractive overlay 24. Features 25 may be grooves that extend the longitudinal length of light member 22. The unbent width of refractive overlay 24 may exceed the straight line distance between the opposing features causing flexible refractive overlay 24 to assume a curved profile. Dashed profile 27 indicates the position of an alternate refractive overlay having an unbent width that is greater than the straight line distance between opposing features 25 and less than the unbent width of overlay 24. Light rays 33 emitted by the LEDs are refracted by overlay 24 (or overlay 27) according to the angle at which they encounter the overlay. Thus, the angle 05 at which light rays 33 encounter lens 30, and ultimately the direction of light rays emanating from aperture 21, is fashioned according to the selected unbent overlay width. Generally, bending the refractive overlay in one plane results in a broader distribution of light exiting the aperture in the plane without broadening the distribution of light exiting the aperture in the opposing perpendicular plane.

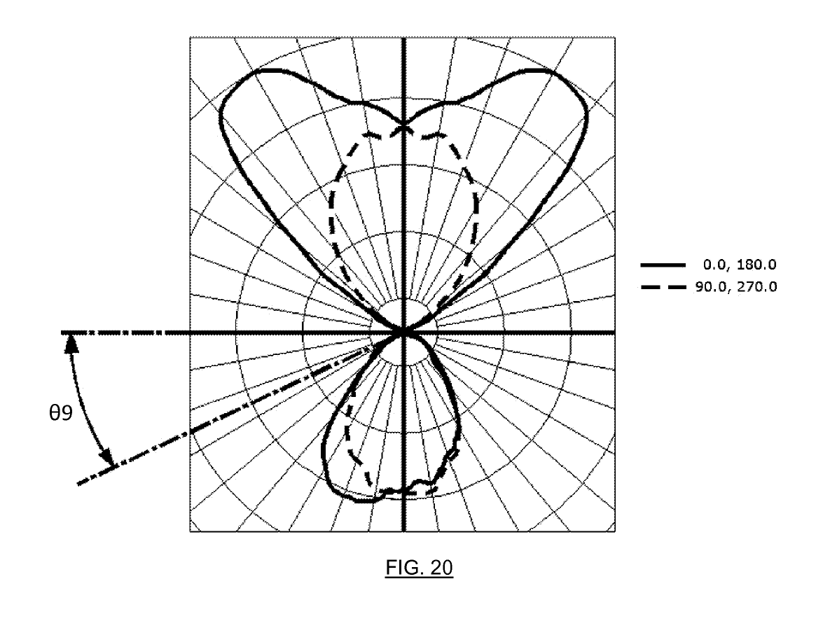

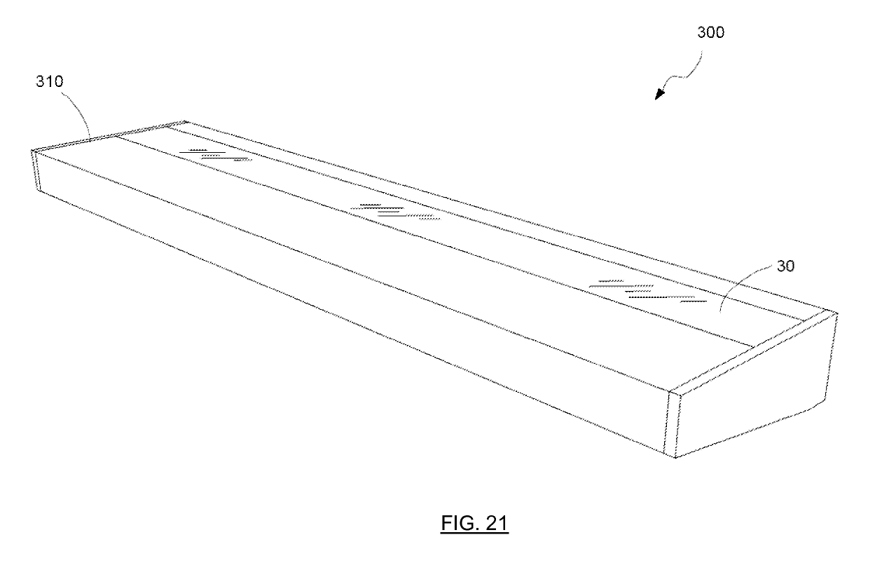

Lens 30 is a homogeneous component with three regions, namely 30a, 30b, and 30c. In another preferred embodiment, lens 30 may have one region or another number of regions. Each region may include unique sets of refractive surface features 32 that determine the ultimate direction 34 of the light rays emanating from each lens section, respectively. Moreover, in accordance with the present disclosure, any region of the lens may be defined by a different material such that the light rays encountering the region are partially or completely absorbed or reflected, or otherwise take on a character 34′ that differs from the ultimate character 34 of light rays that do not encounter the section. In a preferred embodiment, lens 30 provides a widespread, symmetrical “batwing” uplight lighting distribution with reduced low-angle brightness as seen in the upper hemisphere of the candlepower plot shown in FIG. 20.

Similarly, light member 42 includes a flexible refractive overlay 44 and a plurality of LEDs 43 and is associated with housing 60 along mounting plane k-k′ such that housing 60 also serves as a heat transfer member for light member 22. Light member 22 directs light through refractive overlay 44 in the direction of lens 50.

Alternatively, in the case of light member 22 or light member 42 or both, flexible refractive overlay 24 and/or flexible refractive overlay 44 may be a rigid refractive overlay.

Lens 50 is advantageously disposed along plane m-m′ at an angle θ6 to downlight aperture 41 which occurs along plane h-h′. This reduces the angle θ10 between the plane of the lens m-m′ and a typical luminaire viewing angle and serves to reduce glare even as lens 50 is configured to produce an asymmetric distribution of light in the direction of the viewer as seen in the lower hemisphere of the candlepower plot shown in FIG. 20. The disclosed attitude of lens 50 with respect to downlight aperture 41 further provides for a portion of the luminaire housing and heat transfer member 61 to serve as a reflector for certain light rays 54″ emanating from light member 42 thus facilitating an asymmetric forward-throw downlight distribution while maintaining a desirable cut-off angle below the viewing angle θ9.

Lens 50 is a homogeneous component with two regions, namely 50a, 50b. In another preferred embodiment, lens 50 may have one region or another number of regions. Sets of refractive surface features 52 and the material associated with each lens section determine the ultimate direction and intensity of the light rays 54, 54′ and 54″ emanating from the lens. Moreover, in accordance with the present disclosure, any region of the lens may be defined by a different material such that the light rays encountering the region are partially or completely absorbed or reflected, or otherwise take on a character 34′ that differs from the ultimate character 34 of light rays that do not encounter the section.

Mounting extension 71 includes control inputs 90 and 92 for modulating the output of light member 22, or light member 44, or both light members 22, 44 via internal control circuit 15. Control inputs 90, 92 could be one or two control inputs. Control inputs 90 and 92 are momentary contact devices but in another embodiment may be capacitive touch surfaces.

In the present embodiment, light member 22, 44 include reflective portions 26 and 46 respectively that direct light rays toward lens 30 and lens 50, respectively. Furthermore, in the present embodiment or in another embodiment, light member 22 may or may not be identical to light member 44 with respect to the plurality of LEDs 23, 43, and/or with respect to refractive overlay 24, 44, and may or may not be like sized and physically interchangeable.

In the present embodiment or in another embodiment, lens 30 may or may not be like sized with identical or respectively unique snap fit details 31, 51 and may or may not be physically interchangeable. In the instant embodiment or in an alternative embodiment, lens 30 may or may not be reversible. This would enable an asymmetric distribution of light.

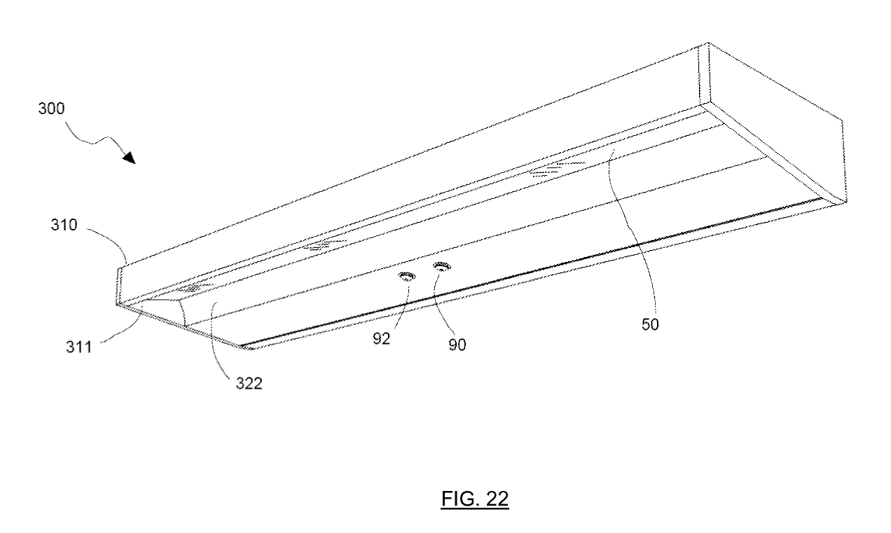

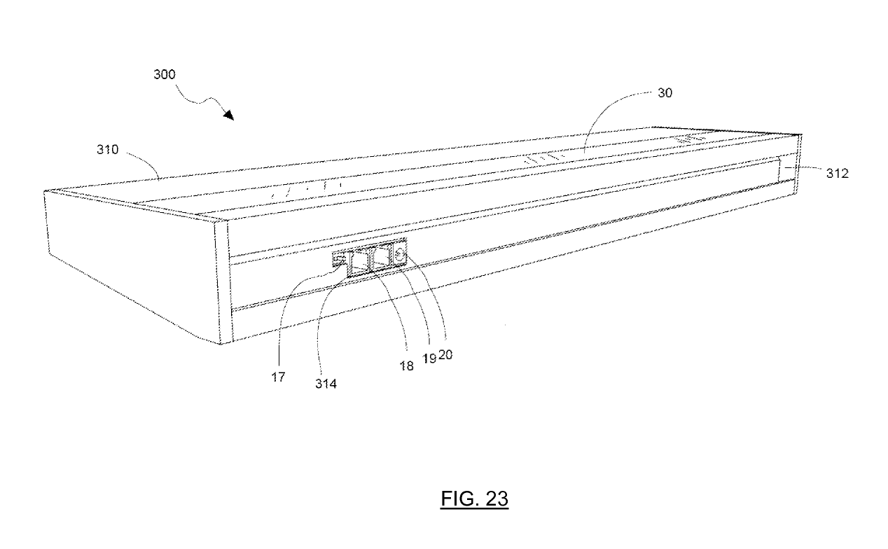

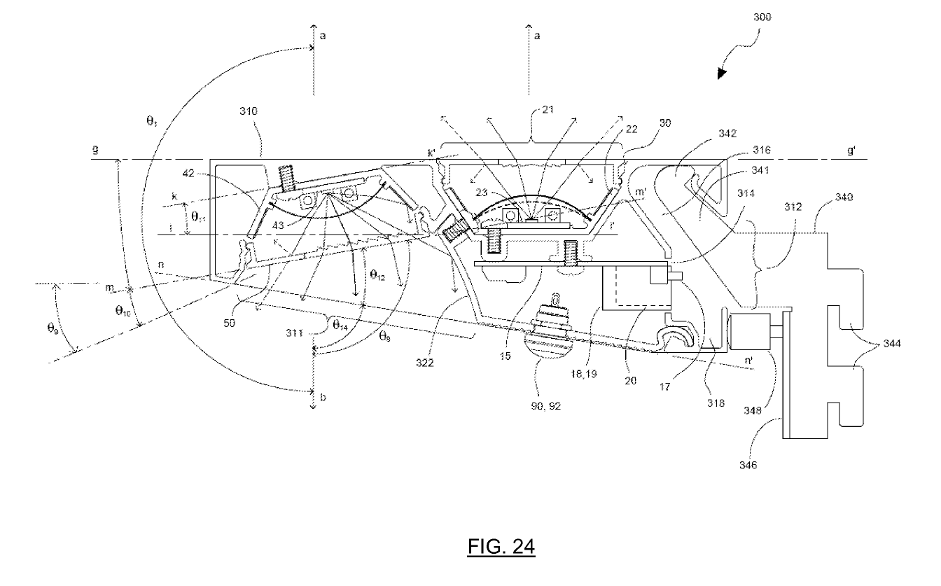

FIGS. 21-24 illustrate another preferred embodiment of the disclosure consisting of a luminaire 301 with internal control circuit 15, downlight aperture 311 disposed in plane n-n′, control inputs 90,92 disposed in reflective closure 322, and with light members 22, 42 and lenses 30, 50 disclosed in the previously described embodiment. Luminaire 301 is further comprised with an opening 314 and an elongated aperture 312 at the rear of the luminaire, the opening sized to accommodate mode switch 17, remote control port 18, remote power and signal port 19, and power input port 20 of internal control circuit 15, and the aperture serving as access to the switch and the ports, as well as to a horizontal cable management channel 318 and a mounting channel 316 configured to accept mounting brackets 340. Specifically, FIG. 24 illustrates a mounting bracket with an upwardly angled neck portion 341, an integrally formed bulbous portion 342 disposed at an upper end of the neck 341, one or more downward facing extensions 344, and a threaded leveling device 348 associated with a mounting extension or flange 346 extending perpendicular to the illustrated crossection.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure with out departing from the essential scope thereof. Therefore, it is intended that the disclosure not be limited to the particular embodiment disclosed as the best mode contemplated for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

What is claimed is:

1. A luminaire comprising:
a luminaire housing having a first aperture emitting light from a first light member and a second aperture emitting light from a second light member, wherein the first and second light members are separated by a heat transfer member and at least one of the light members is mounted on the heat transfer member;
a switch having a first position and a second position configured to modulate a plurality of settings for the first and second light members;
a control unit configured to control the light output from the first and second light members as a function of the switch; and
an operative source disposed in communication with the control unit and configured to instruct the control unit to operate the luminaire through a plurality of modes.

2. A luminaire comprising:
a luminaire housing; and
a lens having one homogenous component configured to emit a multi-distribution profile, wherein a first half of the lens includes a first input port and a second half of the lens includes a second input port, wherein the first half is made of a first material and a second half is made of a second material.

3. The luminaire of claim 2, wherein the first material is the same as that ofthe second material.

4. The luminaire of claim 2, wherein the first material is different from that of the second material.

5. A luminaire comprising:
a luminaire housing having a first aperture emitting light from a first light member and a second aperture emitting light from a second light member;
a switch having a first position and a second position configured to modulate a plurality of settings for the first and second light members;
a control unit configured to control the light output from the first and second light members as a function of the switch;
an operative source disposed in communication with the control unit and configured to instruct the control unit to operate the luminaire through a plurality of modes; and
a lens disposed adjacent at least one of the first and second apertures and having one homogenous component configured to emit a multi-distribution profile, wherein a first half of the lens includes a first input port and a second half of the lens includes a second input port, wherein the first half is made of a first material and a second half is made of a second material.
